(19) United States
(12) Patent Application Publication
(10) Pub. No.: US 2015/0237402 A1
(43) Pub. Date: Aug. 20, 2015

(54) IMAGE DISPLAY APPARATUS, SERVER AND METHOD FOR OPERATING THE SAME

(71) Applicant: LG ELECTRONICS INC., Seoul (KR)

(72) Inventor: Chang Gi Lee, Seoul (KR)

(21) Appl. No.: 14/430,028

(22) PCT Filed: Sep. 9, 2013
(86) PCT No.: PCT/KR2013/008132

§ 371 Date: Mar. 20, 2015

(30) Foreign Application Priority Data
Sep. 21, 2012 (KR) 10-2012-0105357

(51) Int. Cl. H04N 21/472; H04N 21/25

(52) U.S. Cl. CPC H04N 21/47202; H04N 21/251

(57) ABSTRACT

An image display apparatus and a method for operating the same are disclosed. The method for operating an image display apparatus includes receiving user input for requesting content recommendation, transmitting a message requesting information about a user and a content recommendation list to a server, receiving, from the server, the content recommendation list based on content viewing information of other users linked with the user over a social network, displaying the received content recommendation list, receiving input for selecting at least one piece of content from the content recommendation list, and playing back the selected content.

### TECHNICAL FIELD

The present invention relates to an image display apparatus, a server and a method for operating the same, and more particularly to an image display apparatus, a server and a method for operating the same, which are capable of increasing user convenience.

### BACKGROUND ART

An image display apparatus functions to display images to a user. A user can view a broadcast program using an image display apparatus. The image display apparatus can display a broadcast program selected by the user on a display from among broadcast programs transmitted from broadcast stations. The recent trend in broadcasting is a worldwide transition from analog broadcasting to digital broadcasting.

Digital broadcasting transmits digital audio and video signals. Digital broadcasting offers many advantages over analog broadcasting, such as robustness against noise, less data loss, ease of error correction, and the ability to provide clear, high-definition images. Digital broadcasting also allows interactive viewer services, compared to analog broadcasting.

### DISCLOSURE OF INVENTION

### Technical Problem

Therefore, the present invention has been made in view of the above problems, and it is an object of the present invention to provide an image display apparatus, a server and a method for operating the same, which are capable of increasing user convenience.

Another object of the present invention is to provide an image display apparatus, a server and a method for operating the same, which are capable of providing a content recommendation list based on a social network service.

### Solution to Problem

In accordance with an aspect of the present invention, the above and other objects can be accomplished by the provision of a method for operating an image display apparatus, including receiving user input for requesting content recommendation, transmitting a message requesting information about a user and a content recommendation list to a server, receiving, from the server, the content recommendation list based on content viewing information of other users linked with the user over a social network, displaying the received content recommendation list, receiving input for selecting at least one piece of content from the content recommendation list, and playing back the selected content.

In accordance with another aspect of the present invention, there is provided a method for operating a server, including receiving a content recommendation list request message from an image display apparatus, requesting information about other users linked with a user of the image display apparatus over a social network from a server providing a social network service, generating a content recommendation list based on the information about the other users and content use information of the other users, and transmitting the content recommendation list to the image display apparatus.

In accordance with another aspect of the present invention, there is provided an image display apparatus including a network interface configured to receive, from a server, a content recommendation list based on content viewing information of other users linked with a user of the image display apparatus over a social network, a display configured to display the received content recommendation list, and a controller configured to receive input for selecting at least one piece of content from the content recommendation list and to play back the selected content.

### Advantageous Effects of Invention

According to the embodiment of the present invention, a first server collects content use information from an image display apparatus and acquires information about other users from a second server (SNS server). Therefore, it is possible to provide a content recommendation list based on a social network. The image display apparatus displays the content recommendation list such that users linked over the social network can easily share content use information.

The content recommendation list can be generated based on user information such as an age, gender, activity index and area of interest of a user. Therefore, it is possible to generate a content recommendation list according to user preference.

In addition, selected content can be easily played back through input for selecting one piece of content from the content recommendation list.

Accordingly, it is possible to increase user convenience.

### BRIEF DESCRIPTION OF DRAWINGS

The above and other objects, features and other advantages of the present invention will be more clearly understood from the following detailed description taken in conjunction with the accompanying drawings, in which:

FIG. 1 is a diagram showing an image display system according to an embodiment of the present invention;

FIG. 2 is a block diagram showing the internal configuration of an image display apparatus according to an embodiment of the present invention;

FIG. 3 is a block diagram showing the internal configuration of a controller shown in FIG. 2;

FIG. 4 is a diagram showing various formats of a 3D image;

FIG. 5 is a diagram showing operation of a viewing device according to the formats of FIG. 4;

FIG. 6 is a diagram showing various scaling schemes of a 3D image signal according to an embodiment of the present invention;

FIG. 7 is a diagram illustrating an image formed by a left-eye image and a right-eye image;

FIG. 8 is a diagram illustrating the depth of a 3D image according to a disparity between a left-eye image and a right-eye image;

FIG. 9 is a diagram showing a method of controlling a remote controller of FIG. 2;

FIG. 10 is a block diagram showing the internal configuration of the remote controller of FIG. 2;

FIG. 11 is a block diagram showing the internal configuration of a first server of FIG. 1;

FIG. 12 is a flowchart illustrating a method for operating an image display apparatus according to an embodiment of the present invention;

FIG. 13 is a flowchart illustrating a method for operating a server according to an embodiment of the present invention; and

FIGS. 14 to 26 are views referred to for describing various examples of the operating methods of FIGS. 12 and 13.

### BEST MODE FOR CARRYING OUT THE INVENTION

Exemplary embodiments of the present invention will be described with reference to the attached drawings.

The terms “module” and “unit” used in description of components are used herein to help the understanding of the components and thus should not be misconstrued as having specific meanings or roles. Accordingly, the terms “module” and “unit” may be used interchangeably.

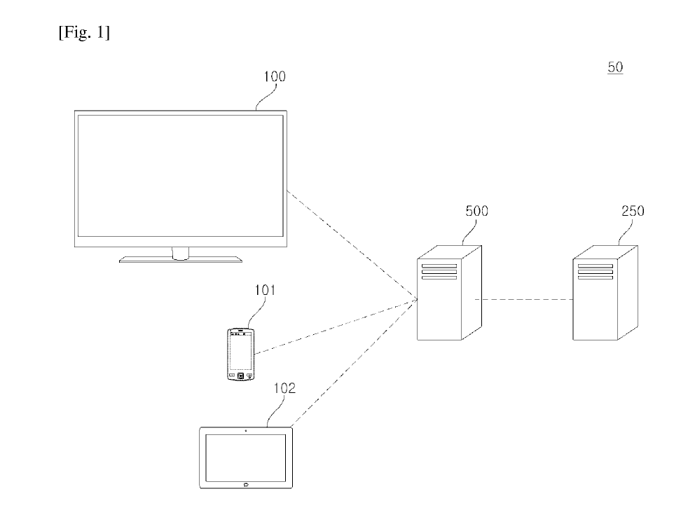

FIG. 1 is a diagram showing an image display system according to an embodiment of the present invention.

Referring to FIG. 1, the image display system 50 according to the present invention may include image display apparatuses 100, 101 and 102, a first server 500 and a second server 250.

The image display apparatuses 100, 101 and 102 may include a digital TV, a mobile terminal, a tablet PC, a monitor and a laptop.

The first server 500 may provide a service for connecting the first image display apparatus 100, the second image display apparatus 101 and the third image display apparatus 102. The first server may be a relay server for connecting the image display apparatuses 100, 101 and 102 and the second server 250.

The first server 500 may have a fixed IP address and the image display apparatus 100, 101 and 102 may access the first server 500 using the fixed IP address.

The second server 250 may provide a social networking service (SNS) to the image display apparatuses 100, 101 and 102. The second server 250 may serve as an SNS server.

The image display apparatuses 100, 101 and 102 may receive an SNS from the second server 250 and a user of the image display apparatuses 100, 101 and 102 may subscribe to the SNS and have an SNS account.

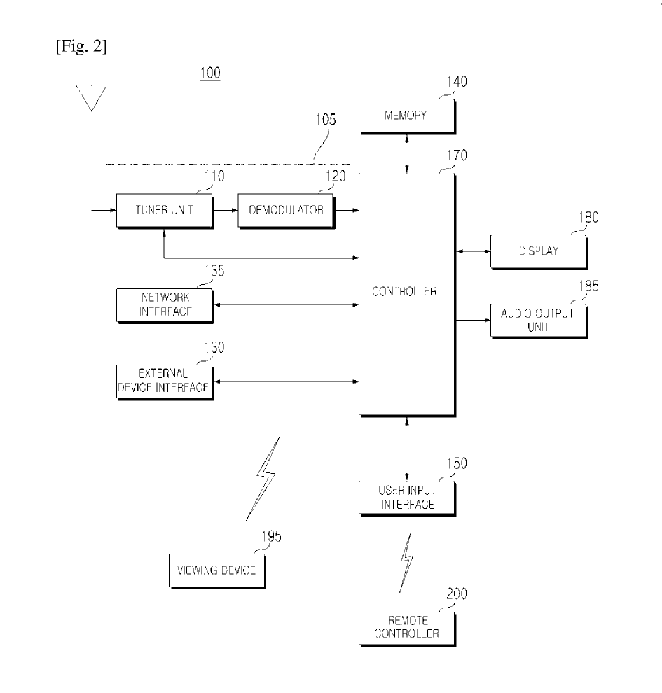

FIG. 2 is a block diagram showing the internal configuration of an image display apparatus according to an embodiment of the present invention.

Referring to FIG. 2, the image display apparatus 100 according to the embodiment of the present invention includes a broadcast reception unit 105, an external device interface 130, a memory 140, a user input interface 150, a sensor unit (not shown), a controller 170, a display 180, an audio output unit 185 and a viewing device 195.

The broadcast reception unit 105 may include a tuner unit 110, a demodulator 120 and a network interface 130. As needed, the broadcasting reception unit 105 may be configured so as to include only the tuner unit 110 and the demodulator 120 or only the network interface 130.

The tuner unit 110 tunes to a Radio Frequency (RF) broadcast signal corresponding to a channel selected by a user from among RF broadcast signals received through an antenna or RF broadcast signals corresponding to all channels previously stored in the image display apparatus. The tuned RF broadcast is converted into an Intermediate Frequency (IF) signal or a baseband Audio/Video (AV) signal.

For example, the tuned RF broadcast signal is converted into a digital IF signal DIF if it is a digital broadcast signal and is converted into an analog baseband AV signal (Composite Video Banking Sync/Sound Intermediate Frequency (CVBS/SIF)) if it is an analog broadcast signal. That is, the tuner unit 110 may be capable of processing not only digital broadcast signals but also analog broadcast signals. The analog baseband A/V signal CVBS/SIF may be directly input to the controller 170.

The tuner unit 110 may be capable of receiving RF broadcast signals from an Advanced Television Systems Committee (ATSC) single-carrier system or from a Digital Video Broadcasting (DVB) multi-carrier system.

The tuner unit 110 may sequentially select a number of RF broadcast signals corresponding to all broadcast channels previously stored in the image display apparatus by a channel storage function from among a plurality of RF signals received through the antenna and may convert the selected RF broadcast signals into IF signals or baseband A/V signals.

The tuner unit 110 may include a plurality of tuners for receiving broadcast signals corresponding to a plurality of channels or include a single tuner for simultaneously receiving broadcast signals corresponding to the plurality of channels.

The demodulator 120 receives the digital IF signal DIF from the tuner unit 110 and demodulates the digital IF signal DIF.

The demodulator 120 may perform demodulation and channel decoding, thereby obtaining a stream signal TS. The stream signal may be a signal in which a video signal, an audio signal and a data signal are multiplexed.

The stream signal output from the demodulator 120 may be input to the controller 170 and thus subjected to demultiplexing and A/V signal processing. The processed video and audio signals are output to the display 180 and the audio output unit 185, respectively.

The external device interface 130 may transmit or receive data to or from a connected external device (not shown). The external device interface 130 may include an A/V input/output (I/O) unit (not shown) or a radio transceiver (not shown).

The external device interface 130 may be connected to an external device such as a

Digital Versatile Disc (DVD) player, a Blu-ray player, a game console, a camera, a camcorder, or a computer (e.g., a laptop computer), wirelessly or by wire so as to perform an input/output operation with respect to the external device.

The A/V I/O unit may receive video and audio signals from an external device. The radio transceiver may perform short-range wireless communication with another electronic apparatus.

The network interface 135 serves as an interface between the image display apparatus 100 and a wired/wireless network such as the Internet. For example, the network interface 135 may receive content or data provided by an Internet or content provider or a network operator over a network.

The memory 140 may store various programs necessary for the controller 170 to process and control signals, and may also store processed video, audio and data signals.

In addition, the memory 140 may temporarily store a video, audio and/or data signal received from the external device interface 130. The memory 140 may store information about a predetermined broadcast channel by the channel storage function of a channel map.

While the memory 140 is shown in FIG. 2 as being configured separately from the controller 170, to which the present invention is not limited, the memory 140 may be incorporated into the controller 170.

The user input interface 150 transmits a signal input by the user to the controller 170 or transmits a signal received from the controller 170 to the user.

For example, the user input interface 150 may transmit/receive various user input signals such as a power-on/off signal, a channel selection signal, and a screen setting signal from a remote controller 200, may provide the controller 170 with user input signals received from local keys (not shown), such as inputs of a power key, a channel key, and a volume key, and setting values, provide the controller 170 with a user input signal received from a sensor unit (not shown) for sensing a user gesture, or transmit a signal received from the controller 170 to a sensor unit (not shown).

The controller 170 may demultiplex the stream signal received from the tuner unit 110, the demodulator 120, or the external device interface 130 into a number of signals, process the demultiplexed signals into audio and video data, and output the audio and video data.

The video signal processed by the controller 170 may be displayed as an image on the display 180. The video signal processed by the controller 170 may also be transmitted to an external output device through the external device interface 130.

The audio signal processed by the controller 170 may be output to the audio output unit 185. In addition, the audio signal processed by the controller 170 may be transmitted to the external output device through the external device interface 130.

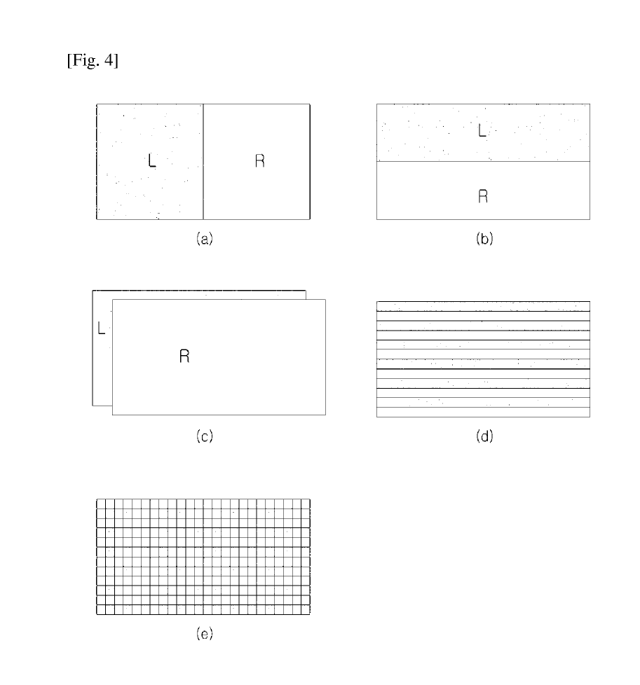

While not shown in FIG. 2, the controller 170 may include a DEMUX, a video processor, etc., which will be described in detail later with reference to FIG. 4.

The controller 170 may control the overall operation of the image display apparatus 100. For example, the controller 170 controls the tuner unit 110 to tune to an RF signal corresponding to a channel selected by the user or a previously stored channel.

The controller 170 may control the image display apparatus 100 according to a user command input through the user input interface 150 or an internal program.

The controller 170 may control the display 180 to display images. The image displayed on the display 180 may be a Two-Dimensional (2D) or Three-Dimensional (3D) still or moving image.

The controller 170 may generate and display a predetermined object of an image displayed on the display 180 as a 3D object. For example, the object may be at least one of a screen of an accessed web site (newspaper, magazine, etc.), an electronic program guide (EPG), various menus, a widget, an icon, a still image, a moving image, text, etc.

Such a 3D object may be processed to have a depth different from that of an image displayed on the display 180. Preferably, the 3D object may be processed so as to appear to protrude from the image displayed on the display 180.

The controller 170 may recognize the position of the user based on an image captured by the camera unit (not shown). For example, a distance (z-axis coordinate) between the user and the image display apparatus 100 may be detected. An x-axis coordinate and a y-axis coordinate in the display 180 corresponding to the position of the user may be detected.

Although not shown, a channel browsing processor for generating a thumbnail image corresponding to a channel signal or an external input signal may be further included. The channel browsing processor may receive the stream signal TS output from the demodulator 120 or the stream signal output from the external device interface 130, extract an image from the received stream signal, and generate a thumbnail image. The generated thumbnail image may be decoded into a stream form to be input to the controller 170 together with the decoded image. The controller 170 may display a thumbnail list including a plurality of thumbnail images on the display 180 using the input thumbnail image.

The thumbnail list may be displayed in a brief viewing method of displaying the thumbnail list in a part of an area in a state of displaying a predetermined image or may be displayed in a full viewing method of displaying the thumbnail list in a full area. The thumbnail images in the thumbnail list may be sequentially updated.

The display 180 converts the video signal, the data signal, the OSD signal and the control signal processed by the controller 170 or the video signal, the data signal and the control signal received by the external device interface 130 and generates a drive signal.

The display 180 may be a Plasma Display Panel (PDP), a Liquid Crystal Display (LCD), an Organic Light-Emitting Diode (OLED) display or a flexible display. In particular, the display 180 may be a 3D display.

For viewing a 3D image, the display 180 may be divided into a supplementary display method and a single display method.

In the single display method, a 3D image is implemented on the display 180 without a separate subsidiary device, for example, glasses. The single display method may include, for example, a lenticular method, a parallax barrier, or the like.

In the supplementary display method, a 3D image is implemented on the display 180 using a subsidiary device as a viewing device 195. The supplementary display method includes various methods such as a Head-Mounted Display (HMD) method or a glasses method.

The glasses method may be divided into a passive method such as a polarized glasses method and an active method such as a shutter glasses method. The HMD method may be divided into a passive method and an active method.

The viewing device 195 may be 3D glasses capable of enabling a user to view a 3D image. The 3D glasses 195 may include passive type polarized glasses, active type shutter glasses or HMD type glasses.

For example, if the viewing device 195 is polarized glasses, a left-eye glass may be implemented by a left-eye polarized glass and a right-eye glass may be implemented by a right-eye polarized glass.

As another example, if the viewing device 195 is shutter glasses, left-eye and right-eye glasses may be alternately opened or closed.

the display 180 is a touchscreen, the display 180 may function as not only an output device but also as an input device.

The audio output unit 185 receives the audio signal processed by the controller 170 and outputs the received audio signal as sound.

The camera unit (not shown) captures images of a user. The camera unit (not shown) may be implemented by one camera, but the present invention is not limited thereto. That is, the camera unit may be implemented by a plurality of cameras. The camera unit (not shown) may be embedded in the image display apparatus 100 at the upper side of the display 180 or may be separately provided. Image information captured by the camera unit (not shown) may be input to the controller 170.

The controller 170 may sense a user gesture from an image captured by the camera unit (not shown), a signal sensed by the sensor unit (not shown), or a combination of the captured image and the sensed signal.

The remote controller 200 transmits user input to the user input interface 150. For transmission of user input, the remote controller 200 may use various communication techniques such as IR communication, RF communication, Bluetooth, Ultra Wideband (UWB) and ZigBee. In addition, the remote controller 200 may receive a video signal, an audio signal or a data signal from the user input interface 150 and output the received signals visually or audibly.

The above-described image display apparatus 100 may be a fixed or mobile digital broadcast receiver capable of receiving a digital broadcast.

The block diagram of the image display apparatus 100 illustrated in FIG. 2 is only exemplary. Depending upon the specifications of the image display apparatus 100 in actual implementation, the components of the image display apparatus 100 may be combined or omitted or new components may be added. That is, two or more components may be incorporated into one component or one component may be configured as separate components, as needed. In addition, the function of each block is described for the purpose of describing the embodiment of the present invention and thus specific operations or devices should not be construed as limiting the scope and spirit of the present invention.

Unlike FIG. 2, the image display apparatus 100 may not include the tuner unit 110 and the demodulator 120 shown in FIG. 2 and may receive broadcast content via the network interface 135 or the external device interface 130 and play the broadcast content back.

The image display apparatus 100 is an example of image signal processing apparatus that processes an image stored in the apparatus or an input image. Other examples of the image signal processing apparatus include a set-top box without the display 180 and the audio output unit 185 shown in FIG. 2, a DVD player, a Blu-ray player, a game console, and a computer.

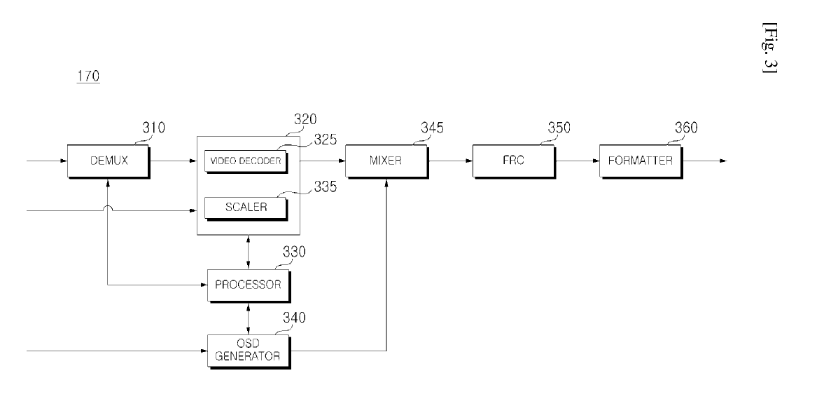

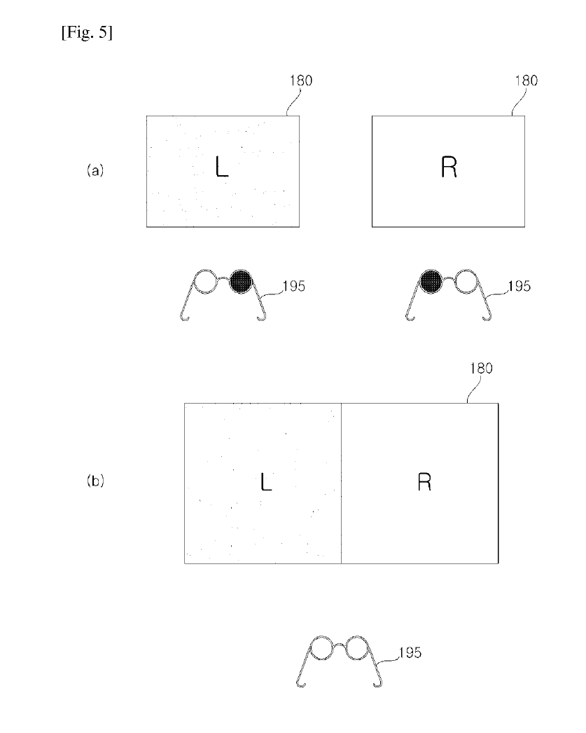

FIG. 3 is a block diagram showing the internal configuration of the controller of FIG. 2, FIG. 4 is a diagram showing various formats of a 3D image, FIG. 5 is a diagram showing operation of a viewing device according to the formats of FIG. 4

Referring to FIG. 3, the controller 170 according to the embodiment of the present invention may include a DEMUX 310, a video processor 320, a processor 330, an OSD generator 340, a mixer 345, a Frame Rate Converter (FRC) 350, and a formatter 360. The controller 170 may further include an audio processor (not shown) and a data processor (not shown).

The DEMUX 310 demultiplexes an input stream. For example, the DEMUX 310 may demultiplex an MPEG-2 TS into a video signal, an audio signal, and a data signal. The stream signal input to the DEMUX 310 may be received from the tuner unit 110, the demodulator 120 or the external device interface 130.

The video processor 320 may process the demultiplexed video signal. For video signal processing, the video processor 320 may include a video decoder 325 and a scaler 335.

The video decoder 325 decodes the demultiplexed video signal and the scaler 335 scales the resolution of the decoded video signal so that the video signal can be displayed on the display 180.

The video decoder 325 may be provided with decoders that operate based on various standards.

The video signal decoded by the video processor 320 may include a 2D video signal, a mixture of a 2D video signal and a 3D video signal, or a 3D video signal.

For example, if an external video signal received from the external device (not shown) or a broadcast video signal received from the tuner unit 110 includes a 2D video signal, a mixture of a 2D video signal and a 3D video signal, or a 3D video signal. Thus, the controller 170 and, more particularly, the video processor 320 may perform signal processing and output a 2D video signal, a mixture of a 2D video signal and a 3D video signal, or a 3D video signal.

The decoded video signal from the video processor 320 may have any of various available formats. For example, the decoded video signal may be a 3D video signal composed of a color image and a depth image or a 3D video signal composed of multi-view image signals. The multi-view image signals may include, for example, a left-eye image signal and a right-eye image signal.

As shown in FIG. 4, formats of the 3D video signal may include a side-by-side format (FIG. 4a) in which the left-eye image signal L and the right-eye image signal R are arranged in a horizontal direction, a top/down format (FIG. 4b) in which the left-eye image signal and the right-eye image signal are arranged in a vertical direction, a frame sequential format (FIG. 4c) in which the left-eye image signal and the right-eye image signal are time-divisionally arranged, an interlaced format (FIG. 4d) in which the left-eye image signal and the right-eye image signal are mixed in line units, and a checker box format (FIG. 4e) in which the left-eye image signal and the right-eye image signal are mixed in box units.

The processor 330 may control overall operation of the image display apparatus 100 or the controller 170. For example, the processor 330 may control the tuner unit 110 to tune to an RF broadcast corresponding to an RF signal corresponding to a channel selected by the user or a previously stored channel.

The processor 330 may control the image display apparatus 100 by a user command input through the user input interface 150 or an internal program.

The processor 330 may control data transmission of the network interface 135 or the external device interface 130.

The processor 330 may control the operation of the DEMUX 310, the video processor 320 and the OSD generator 340 of the controller 170.

The OSD generator 340 generates an OSD signal autonomously or according to user input. For example, the OSD generator 340 may generate signals by which a variety of information is displayed as graphics or text on the display 180, according to user input signals. The OSD signal may include a variety of data such as a User Interface (UI), a variety of menus, widgets, icons, etc. In addition, the OSD signal may include a 2D object and/or a 3D object.

The OSD generator 340 may generate a pointer which can be displayed on the display according to a pointing signal received from the remote controller 200. In particular, such a pointer may be generated by a pointing signal processor and the OSD generator 340 may include such a pointing signal processor (not shown). Alternatively, the pointing signal processor (not shown) may be provided separately from the OSD generator 340.

The mixer 345 may mix the decoded video signal processed by the video processor 320 with the OSD signal generated by the OSD generator 340. Each of the OSD signal and the decoded video signal may include at least one of a 2D signal and a 3D signal. The mixed video signal is provided to the FRC 350.

The FRC 350 may change the frame rate of an input image. The FRC 350 may maintain the frame rate of the input image without frame rate conversion.

The formatter 360 may arrange a left-eye video frame and a right-eye video frame of the 3D video signal subjected to frame rate conversion. The formatter 360 may output a synchronization signal Vsync for opening the left-eye glass and the right-eye glass of the 3D viewing device 195.

The formatter 360 may receive the signal mixed by the mixer 345, that is, the OSD signal and the decoded video signal, and separate a 2D video signal and a 3D video signal.

In the present specification, a 3D video signal refers to a signal including a 3D object such as a Picture-In-Picture (PIP) image (still or moving), an EPG that describes broadcast programs, a menu, a widget, an icon, text, an object within an image, a person, a background, or a web page (e.g. from a newspaper, a magazine, etc.).

The formatter 360 may change the format of the 3D video signal, for example, to one of the various formats illustrated in FIG. 5. As shown in FIG. 5, an operation of a 3D viewing device of a glasses type may be performed according to the format.

FIG. 5(a) illustrates an exemplary operation of the 3D viewing device 195 and, more particularly, the shutter glasses 195 in the case where the formatter 360 outputs the frame sequential format illustrated in FIG. 4.

When the left-eye image L is displayed on the display 180, the left lens of the shutter glasses 195 is opened and the right lens is closed. When the right-eye image R is displayed on the display 180, the left lens of the shutter glasses 195 is closed and the right lens is opened.

FIG. 5(b) illustrates an exemplary operation of the 3D viewing device 195 and, more particularly, the polarized glasses 195 in the case where the formatter 360 outputs the side-by-side format illustrated in FIG. 4. The 3D viewing device 195 illustrated in FIG. 5(b) may be shutter glasses. The shutter glasses may operate like the polarized glasses by maintaining both the left-eye lens and the right-eye lens in an open state.

Meanwhile, the formatter 360 may convert a 2D video signal into a 3D video signal. For example, the formatter 360 may detect edges or a selectable object from the 2D video signal and generate a 3D video signal with an object based on the detected edges or the selectable object. As described before, the 3D video signal may be separated into left-eye and right-eye image signals L and R.

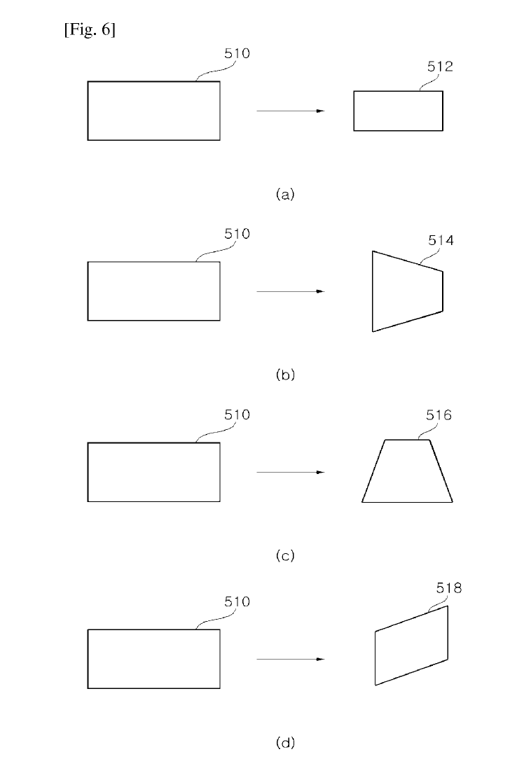

Although not shown, a 3D processor (not shown) for 3D effect signal processing may be further provided next to the formatter 360. The 3D processor (not shown) may control brightness, tint, and color of the video signal, for 3D effect improvement. For example, a short-distance video signal may be clearly processed and a long-distance video signal may be blurredly processed. The function of the 3D processor may be incorporated into the formatter 30 or the video processor 320, which will be described later with reference to FIG. 6.

The audio processor (not shown) of the controller 170 may process the demultiplexed audio signal. For audio processing, the audio processor (not shown) may include various decoders.

The audio processor (not shown) of the controller 170 may control bass, treble, and volume of the audio signal.

The data processor (not shown) of the controller 170 may process the demultiplexed data signal. For example, if the demultiplexed data signal was encoded, the data processor may decode the data signal. The encoded data signal may be Electronic Program Guide (EPG) information including broadcasting information such as the start time, end time, etc. of broadcast programs of each channel.

Although the signals from the OSD generator 340 and the video processor 320 are mixed by the mixer 345 and then are subjected to 3D processing by the formatter 360 in FIG. 3, the present invention is not limited thereto and the mixer may be located at the next stage of the formatter. That is, the formatter 360 may perform 3D processing with respect to the output of the video processor 320, the OSD generator 340 may perform OSD generation and 3D processing, and then the mixer 345 may mix the processed 3D signals.

The block diagram of the controller 170 shown in FIG. 3 is exemplary. The components of the block diagrams may be integrated or omitted, or a new component may be added.

In particular, the FRC 350 and the formatter 360 may not be provided in the controller 170 and may be provided separately from the controller 170.

FIG. 6 is a diagram showing various scaling schemes of a 3D image signal according to an embodiment of the present invention.

Referring to FIG. 6, in order to increase the 3D effect, the controller 170 may perform 3D effect signal processing. In particular, the size or slope of a 3D object in a 3D image may be controlled.

A 3D video signal or a 3D object 510 of the 3D video signal may be enlarged or reduced to a predetermined ratio (512) as shown in FIG. 6(a) or the 3D object may be partially enlarged or reduced (trapezoids 514 and 516) as shown in FIGS. 6(b) and 6(c). As shown in FIG. 6(d), the 3D object may be at least partially rotated (parallelogram 518). By scaling (size control) or slope control, the 3D effect of the 3D image or the 3D object of the 3D image may be increased.

As the slope is increased, a difference between the lengths of both parallel sides of the trapezoids 514 and 516 may be increased as shown in FIG. 6(b) or 6(c) or a rotation angle is increased as shown in FIG. 6(d).

Size control or slope control may be performed after the 3D video signal is converted into a predetermined format by the formatter 360 or may be performed by the scaler of the video processor 320. In addition, the OSD generator 340 may generate an OSD signal so as to generate an object in shapes shown in FIG. 6, in order to increase the 3D effect.

Although not shown, as signal processing for the 3D effect, signal processing such as control of brightness, tint, and color of the video signal or the object may be performed in addition to size control or slope control shown in FIG. 6. For example, a short-distance video signal may be clearly processed and a long-distance video signal may be blurredly processed. Signal processing for the 3D effect may be performed by the controller 170 or a separate 3D processor. If signal processing for the 3D effect is performed by the controller 170, signal processing for the 3D effect may be performed by the formatter 360 or the video processor 320 along with size control or slope control.

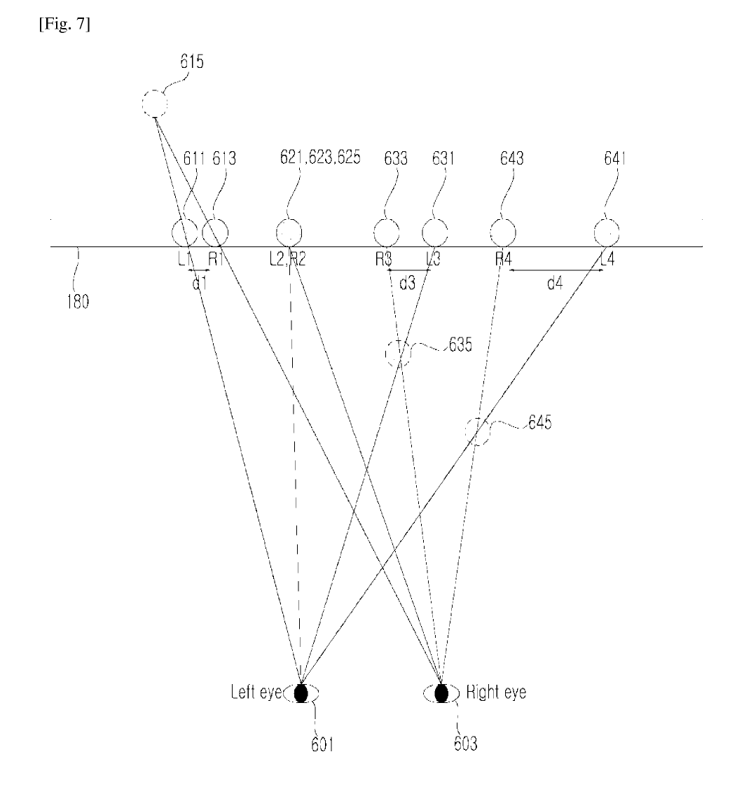

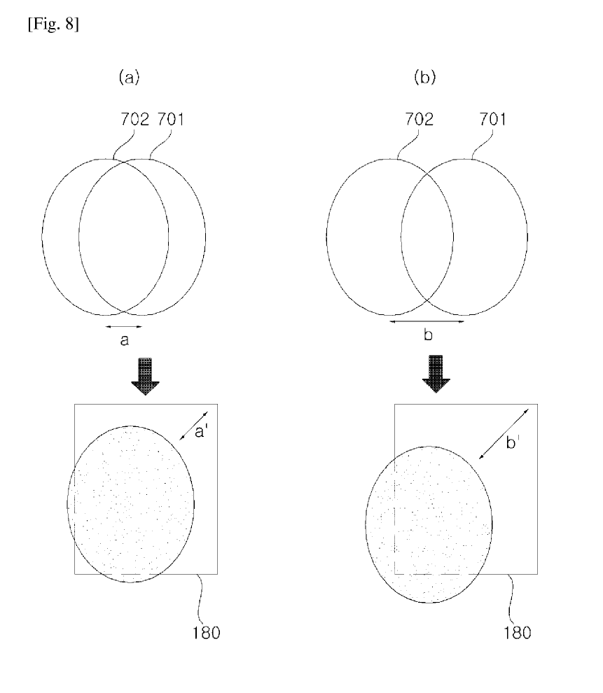

FIG. 7 is a diagram explaining an image formed by a left-eye image and a right-eye image, and FIG. 8 is a diagram explaining the depth of a 3D image according to a disparity between a left-eye image and a right-eye image.

First, referring to FIG. 7, a plurality of images or a plurality of objects 615, 625, 635 or 645 is shown.

A first object 615 includes a first left-eye image 611 (L) based on a first left-eye image signal and a first right-eye image 613 (R) based on a first right-eye image signal, and a disparity between the first left-eye image 611 (L) and the first right-eye image 613 (R) is d1 on the display 180. The user sees an image as formed at the intersection between a line connecting a left eye 601 to the first left-eye image 611 and a line connecting a right eye 603 to the first right-eye image 613. Therefore, the user perceives the first object 615 as being located behind the display 180.

Since a second object 625 includes a second left-eye image 621 (L) and a second right-eye image 623 (R), which are displayed on the display 180 to overlap, a disparity between the second left-eye image 621 and the second right-eye image 623 is 0. Thus, the user perceives the second object 625 as being on the display 180.

A third object 635 includes a third left-eye image 631 (L) and a third right-eye image 633 (R) and a fourth object 645 includes a fourth left-eye image 641 (L) and a fourth right-eye image 643 (R). A disparity between the third left-eye image 631 and the third right-eye images 633 is d3 and a disparity between the fourth left-eye image 641 and the fourth right-eye image 643 is d4.

The user perceives the third and fourth objects 635 and 645 at image-formed positions, that is, as being positioned before the display 180.

Because the disparity d4 between the fourth left-eye image 641 (L) and the fourth right-eye image 643 (R) is greater than the disparity d3 between the third left-eye image 631 (L) and the third right-eye image 633 (R), the fourth object 645 appears to be positioned closer to the viewer than the third object 635.

In embodiments of the present invention, the distances between the display 180 and the objects 615, 625, 635 and 645 are represented as depths. When an object is perceived as being positioned behind the display 180, the depth of the object has a negative value (−). On the other hand, when an object is perceived as being positioned before the display 180, the depth of the object has a positive value (+). Therefore, as an object appears closer to the user, the depth of the object is larger.

Referring to FIG. 8, if the disparity a between a left-eye image 701 and a right-eye image 702 in FIG. 8(a) is smaller than the disparity b between the left-eye image 701 and the right-eye image 702 in FIG. 8(b), the depth a′ of a 3D object created in FIG. 8(a) is smaller than the depth b′ of a 3D object created in FIG. 8(b).

In the case where a left-eye image and a right-eye image are combined into a 3D image, the positions of the images perceived by the user may changed by the disparity between the left-eye image and the right-eye image. This means that the depth of a 3D image or 3D object formed with a left-eye image and a right-eye image in combination may be controlled by adjusting the disparity between the left-eye and right-eye images.

FIG. 9 is a diagram showing a method of controlling the remote controller of FIG. 2.

FIG. 9(a) illustrates a pointer 205 representing movement of the remote controller 200 displayed on the display 180.

The user may move or rotate the remote controller 200 up and down, side to side (FIG. 9(b)), and back and forth (FIG. 9(c)). The pointer 205 displayed on the display 180 of the image display apparatus corresponds to the movement of the remote controller 200. Since the pointer 205 moves in accordance with the movement of the remote controller 200 in a 3D space, the remote controller 200 may be referred to as a pointing device.

Referring to FIG. 9(b), if the user moves the remote controller 200 to the left, the pointer 205 moves to the left on the display 180 of the image display apparatus.

Information about the movement of the remote controller 200 sensed by the sensor of the remote controller 200 is transmitted to the image display apparatus. The image display apparatus may calculate the coordinates of the pointer 205 from the information about the movement of the remote controller 200. Then, the image display apparatus may display the pointer 205 at the calculated coordinates.

Referring to FIG. 9(c), while pressing a predetermined button of the remote controller 200, the user moves the remote controller 200 away from the display 180. Then, a selection area corresponding to the pointer 205 may be zoomed in on and enlarged on the display 180. On the contrary, if the user moves the remote controller 200 toward the display 180, the selection area corresponding to the pointer 205 is zoomed out and thus contracted on the display 180. Alternatively, when the remote controller 200 moves away from the display 180, the selection area may be zoomed out and when the remote controller 200 approaches the display 180, the selection area may be zoomed in.

With the predetermined button pressed in the remote controller 200, the up, down, left and right movements of the remote controller 200 may be ignored. That is, when the remote controller 200 moves away from or approaches the display 180, only the back and forth movements of the remote controller 200 are sensed, while the up, down, left and right movements of the remote controller 200 are ignored. Unless the predetermined button is pressed in the remote controller 200, the pointer 205 moves in accordance with the up, down, left or right movement of the remote controller 200.

The speed and direction of the pointer 205 may correspond to the speed and direction of the remote controller 200.

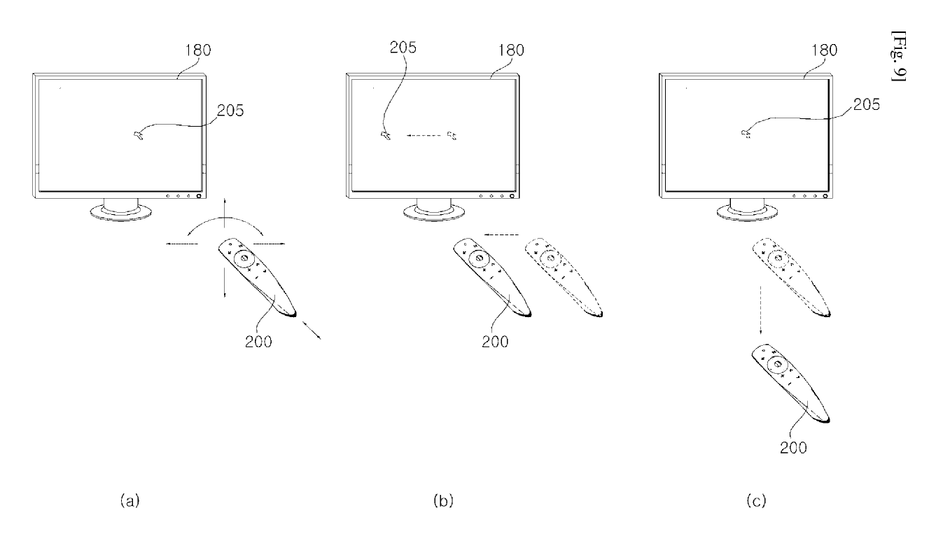

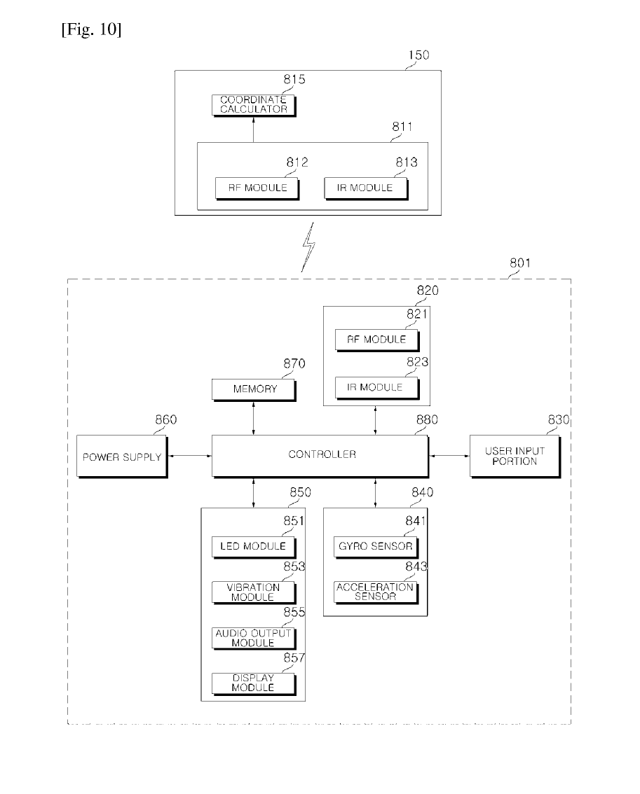

FIG. 10 is a block diagram showing the internal configuration of the remote controller of FIG. 2.

Referring to FIG. 10, the remote controller 200 may include a wireless communication module 825, a user input unit 835, a sensor unit 840, an output unit 850, a power supply 860, a memory 870, and a controller 880.

The wireless communication module 825 transmits signals to and/or receives signals from either of the afore-described image display apparatuses according to the embodiments of the present invention, herein, the image display apparatus 100.

In the present embodiment, the remote controller 200 may include an RF module 821 for transmitting or receiving signals to or from the image display apparatus 100 according to an RF communication standard. The remote controller 200 may also include an IR module 823 for transmitting or receiving signals to or from the image display apparatus 100 according to an IR communication standard.

In the present embodiment, the remote controller 200 transmits information about the movement of the remote controller 200 to the image display apparatus 100 through the RF module 821.

The remote controller 200 may also receive signals from the image display apparatus 100 through the RF module 821. As needed, the remote controller 200 may transmit commands such as a power on/off command, a channel switch command, or a volume change command to the image display apparatus 100 through the IR module 823.

The user input unit 835 may include a keypad, a plurality of buttons, a touchpad and/or a touch screen. The user may enter commands to the image display apparatus 100 by manipulating the user input unit 835. If the user input unit 835 includes hard buttons, the user may input various commands to the image display apparatus 100 by pressing the hard buttons. If the user input unit 835 includes a touch screen displaying soft keys, the user may input various commands to the image display apparatus 100 by touching the soft keys. The user input unit 835 may also include various input tools other than those set forth herein, such as a scroll key and/or a jog wheel, which should not be construed as limiting the present invention.

The sensor unit 840 may include a gyroscopic sensor 841 and/or an acceleration sensor 843. The gyroscopic sensor 841 may sense the movement of the remote controller 200.

For example, the gyroscopic sensor 841 may sense the movement of the remote controller 200 in X-, Y-, and Z-axis directions, and the acceleration sensor 843 may sense the speed of the remote controller 200. The sensor unit 840 may further include a distance sensor for sensing the distance between the remote controller and the display 180.

The output unit 850 may output a video and/or audio signal corresponding to manipulation of the user input unit 835 or corresponding to a signal received from the image display apparatus 100. The user may easily identify whether the user input unit 835 has been manipulated or whether the image display apparatus 100 has been controlled, based on the video and/or audio signal output by the output unit 850.

For example, the output unit 850 may include a Light Emitting Diode (LED) module 851 which is turned on or off whenever the user input unit 835 is manipulated or whenever a signal is received from or transmitted to the image display apparatus 100 through the wireless communication module 825, a vibration module 853 which generates vibrations, an audio output module 855 which outputs audio data, and/or a display module 857 which outputs video data.

The power supply 860 supplies power to the remote controller 200. If the remote controller 200 is kept stationary for a predetermined time or longer, the power supply 860 may, for example, reduce or shut off supply of power to the remote controller 200 in order to save power. The power supply 860 may resume power supply if a predetermined key on the remote controller 200 is manipulated.

The memory 870 may store various types of programs and application data necessary to control or drive the remote controller 200. The remote controller 200 may wirelessly transmit signals to and/or receive signals from the image display apparatus 100 over a predetermined frequency band through the RF module 821. The controller 880 of the remote controller 200 may store information regarding the frequency band used for the remote controller 200 to wirelessly transmit signals to and/or wirelessly receive signals from the paired image display apparatus 100 in the memory 870, for later use.

The controller 880 provides overall control to the remote controller 200. The controller 880 may transmit a signal corresponding to a key manipulation detected from the user input unit 835 or a signal corresponding to the movement of the remote controller 200, as sensed by the sensor unit 840, to the image display apparatus 100 through the wireless communication unit 825.

The user input interface 150 of the image display apparatus 100 may include a wireless communication unit 811 for wirelessly transmitting or receiving a signal to or from the remote controller and a coordinate calculator 815 for calculating the coordinates of the pointer corresponding to the motion of the remote controller 200.

The wireless communication unit 811 may wirelessly transmit to or receive a signal from the remote controller 200 through the RF module 812. The remote controller 200 may receive a signal transmitted according to the IR communication standard through the IR module 813.

The coordinate calculator 815 may compensate for hand shakiness or remove error from the signal corresponding to the motion of the remote controller 200 received through the wireless communication unit 811 and calculate the coordinates (x, y) of the pointer to be displayed on the display 180.

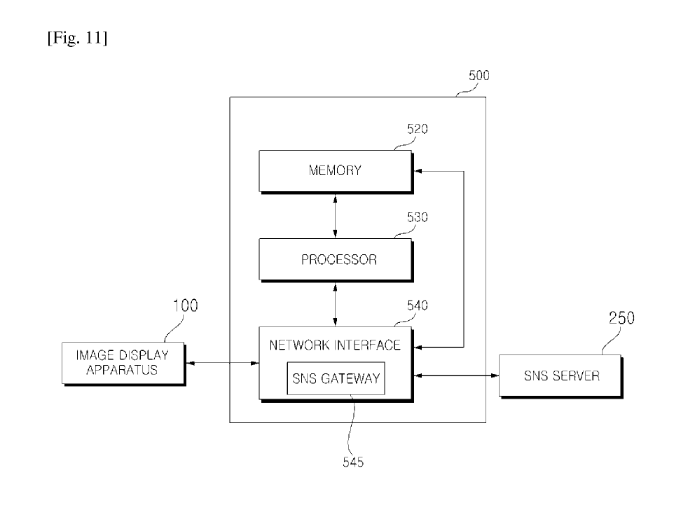

FIG. 11 is a block diagram showing the internal configuration of the first server of FIG. 1.

Referring to FIG. 11, the first server may include a memory 520, a processor 530 and a network interface 540. The network interface 540 may include an SNS gateway 545. The SNS gateway 545 may receive user identification information from the image display apparatus 100 and log in to the SNS server 250. The user identification information may include at least one of a user identifier for identifying a user, a session identifier for identifying a session of a current user with the SNS server 250 and a session identifier secret of a current user.

In addition, the network interface 540 may receive data related to content information from the image display apparatus and store the data in the memory 520. The content information may include at least one of content posting information and content playback information.

The content posting information may include at least one of a country code, a region code, a session identifier, a session identifier secret, a content name, a content module name, a content description, a content thumbnail universal resource locator (URL), a content thumbnail binary, a recommendation message and a web URL. The country code is assigned to each country in order to identify a country, the region code is assigned to each region in order to identify a region, and the session identifier is used to identify a session with an SNS server. The session identifier may include at least one of session ID, token and cookie. The session identifier secret indicates a secret of a session identifier, the content name indicates the name of content, and the content module name indicates the type of content. The content thumbnail URL indicates the location of a content thumbnail, the content thumbnail binary is image data of a content thumbnail, and the web URL indicates the location of an information page of content.

The content playback information may include at least one of content type information, an audio ID (an audio identifier), a content ID (a content identifier), a channel name, a physical channel number, a primary channel number, a secondary channel number, a source index, a start time and an end time. The content type information indicates information about a content type, and the content type may include at least one of text, image, audio, video, real-time broadcast program and application.

If content is a real-time broadcast program, the content information may mean broadcast information. At this time, the broadcast information may include at least one of a channel name, a physical channel number, a primary channel number, a secondary channel number, a source index, a broadcast program name, a broadcast start time and a broadcast end time.

The data related to such content information may include an identifier or a data ID for identifying data per content or transaction and may be stored for search using the ID.

The content information and the user identification information may be linked and stored.

The SNS gateway 545 may receive, from the SNS server 250, information necessary to generate a content recommendation list based on a social network, for example, information about other users linked with the user over the social network, such as an SNS friend list.

The processor 530 may acquire an SNS account associated with the content information received from the image display apparatus 100 and generate a content recommendation list using the information about the other users received from the SNS server 250. If content is a real-time broadcast program, the content recommendation list may include real-time broadcast program information, the number of real-time viewers, information about other users who are currently viewing content, etc.

The network interface 540 may transmit the generated content recommendation list to the image display apparatus 100.

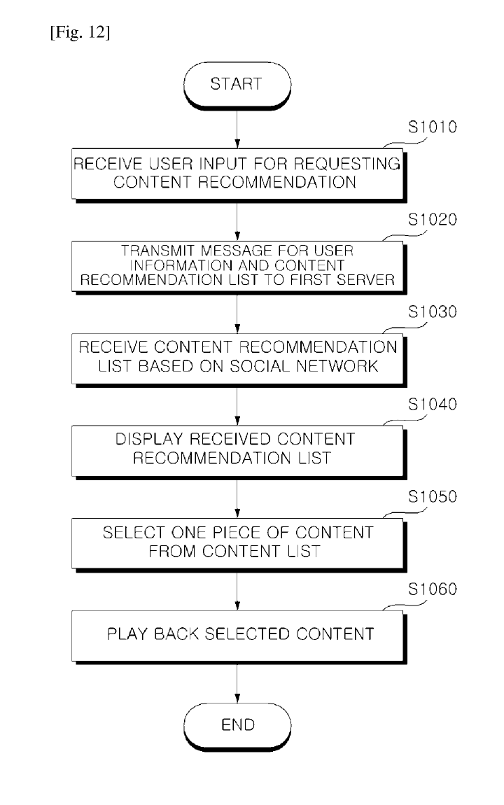

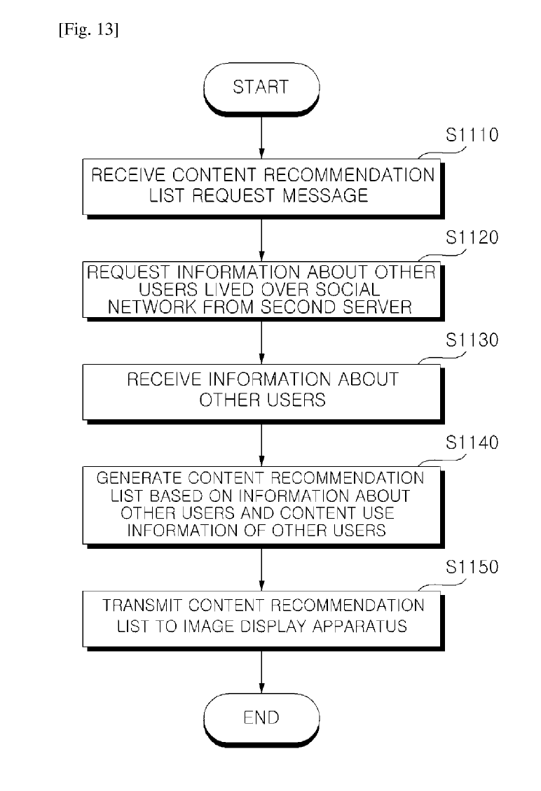

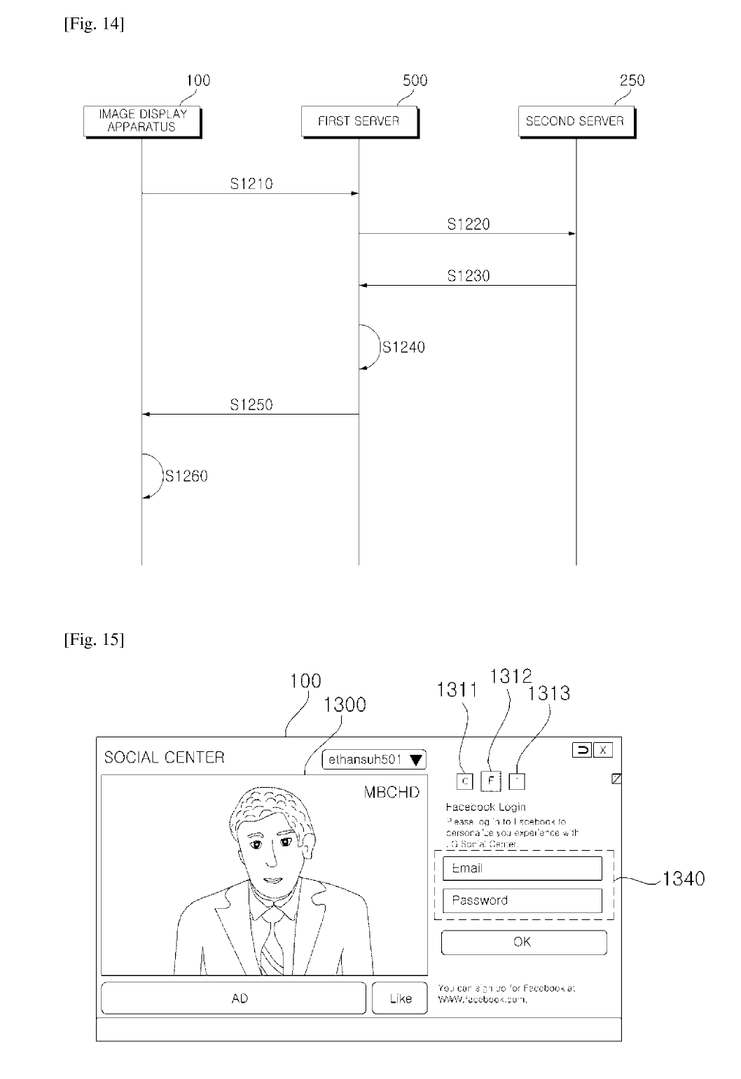

FIG. 12 is a flowchart illustrating a method for operating an image display apparatus according to an embodiment of the present invention, FIG. 13 is a flowchart illustrating a method for operating a first server according to an embodiment of the present invention, and FIGS. 14 to 26 are views referred to for describing various examples of the operating methods of FIGS. 12 and 13.

First, the image display apparatus 100 receives user input for requesting content recommendation (S1010). Content recommendation may be requested based on a social network and user input for requesting content recommendation based on the social network may serve to select any one of objects 1311, 1312 and 1313 indicating social network services after a social network application has been executed.

Alternatively, user input for requesting content recommendation based on the social network may serve to select a plurality of objects from the objects 1311, 1312 and 1313 indicating the social network services. If a plurality of objects indicating the social network services is selected, a recommendation content list may be requested based on the plurality of selected social network services.

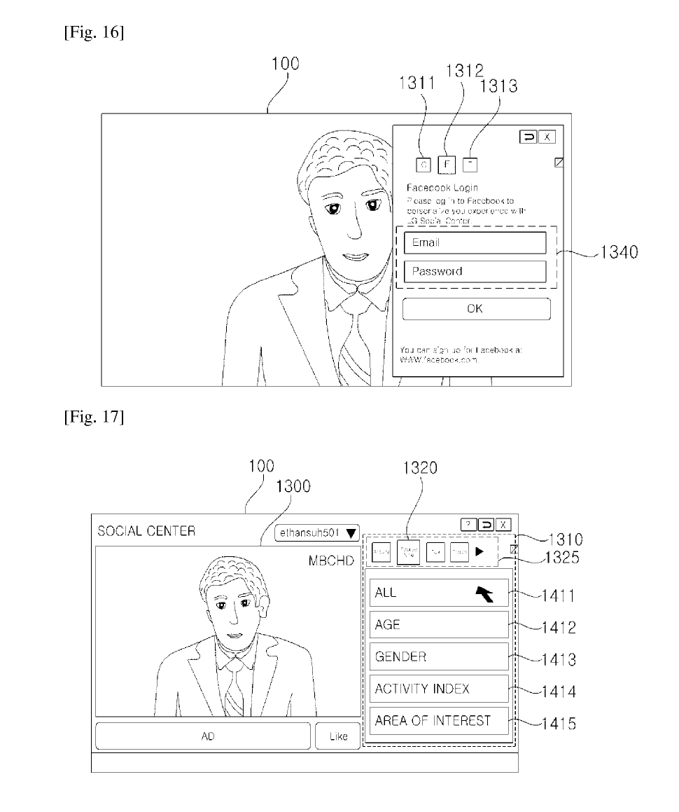

Alternatively, as shown in FIG. 16, the objects 1311, 1312 and 1313 may be displayed in the form of an indicator drawer 1350 such that content recommendation may be easily requested even while the user views the image display apparatus.

Step S1010 may correspond to step S1210 of FIG. 14.

If user input for requesting content recommendation is received, a message requesting user information and a content recommendation list is transmitted to the first server 500 (S1020).

At this time, the user information may include authentication information for enabling the user to log in to the SNS server.

As shown in FIGS. 15 and 16, if the user does not log in to the SNS server 250 corresponding to the selected object 1312, a login page 1340 for receiving authentication information for logging in to the SNS server 250 may be displayed. The authentication information may include at least one of an ID, an email address and a password.

The controller 170 may control transmission of the received authentication information to the first server 500, and the first server 500 may store the received authentication information and log in to the SNS server 250 using the authentication information.

Step S1020 may correspond to step S1220 of FIG. 14.

The first server 500 receives a message requesting a content recommendation list from the image display apparatus 100 (S1110) and requests, from the second server 250, information about other users linked with the user over the social network (S1120).

Step S1120 may correspond to step S1230 of FIG. 14.

The first server 500 receives the information about the other users (S1130) and generates a content recommendation list based on the information about the other users and content use information of the other users (S1140).

At this time, if the first server 500 receives the request for the content recommendation list based on a plurality of social networks from the image display apparatus 100, the first server 500 may compare social network IDs, accounts or user information of the other users linked over the social networks and determine whether the other users linked over the social networks are the same.

For example, if a content recommendation list based on a first social network and a second social network are requested, the social network ID, account and user information of a second user linked with a user (first user) of the image display apparatus 100 over the first social network and the social network ID, account and user information of a third user linked with the first user over the second social network are compared. If it is determined that the second user and the third user are the same, the second user and the third user may be recognized as the same user to generate the content recommendation list.

When the content recommendation list is generated, it is possible to prevent the same user linked over different social networks from being repeatedly displayed.

Step S1130 may correspond to step S1240 of FIG. 14 and step S1140 may correspond to step S1250 of FIG. 14.

At this time, the generated content recommendation list is transmitted to the image display apparatus (S1150).

The image display apparatus 100 may receive the content recommendation list based on the social network from the first server (S1030). The received content recommendation list may be displayed on the display 180 (S1050).

Step S1150 may correspond to step S1260 of FIG. 14 and step 1050 may correspond to step S1270 of FIG. 14.

For example, as shown in FIG. 17, on the display 180, a currently viewed content image is displayed in a first area 1300 and a menu item 1325 indicating various services provided by the social network is displayed in a second area 1310. The menu item 1325 includes an object 1320 indicating a popular now service.

The popular now service provides the content recommendation list based on the social network. If the object 1320 indicating the popular now service is selected, a sub menu shown in FIG. 17 may be displayed. The sub menu may include a plurality of objects 1411, 1412, 1413, 1414 and 1415.

The plurality of objects 1411, 1412, 1413, 1414 and 1415 may indicate targets for generating the content recommendation list.

For example, if the “all” object 1411 is selected, the content recommendation list may be for all other users linked with the user of the image display apparatus 100 over the social network.

In the present specification, the content recommendation list may be based on all users subscribing to the social network. More preferably, other users linked with the user of the image display apparatus 100 over the social network may be registered with the social network service by the user of the image display apparatus as friends.

According to one embodiment of the present invention, the user of the image display apparatus 100 may directly set friends in a plurality of groups and utilize a content recommendation list based on statistics of each group.

Alternatively, predetermined classification criteria such as the age object 1412, the gender object 1413 and the activity index object 1414 may be selected and applied such that recommended content for users classified according to predetermined criteria may be received.

If the age object 1412 is selected, a content recommendation list for other users of an age group equal to or similar to the age of the user may be generated. If the gender object 1413 is selected, a content recommendation list for other users the same gender as the user may be generated.

In addition, if the activity index object 1414 is selected, a content recommendation list for other users having an activity index equal to or greater than that of the user may be generated and, if the area of interest object 1415 is selected, a content recommendation list for users having the same area of interest as the user may be generated.

More specifically, if the “all” object 1411 is selected, a content list for all other users linked with the user may be generated and displayed in order of content popularity. For example, if the user performs the above-described operation while viewing a real-time broadcast program, a real-time broadcast program list may be generated and displayed in order of ratings of real-time broadcast programs. Alternatively, if the user performs the above-described operation while the user plays game content, a list may be generated and displayed in order of use frequency of game content during a predetermined period.

If the age object 1412 is selected, a content list for an age group similar to the age of the user may be generated and displayed in order of content popularity.

If the gender object 1413 is selected, a content list for users having the same gender may be generated and displayed in order of content popularity.

If the activity index object 1414 is selected, a content list for other users having an activity index equal to or greater than that of the user may be generated and displayed in order of content popularity. At this time, the activity index indicates information exchange between the users over the social network and includes writing something on mutual feeds of the network or sending a message.

If the area of interest object 1415 is selected, a content list for other users having the same area of interest as the user may be generated and displayed in order of content popularity.

Alternatively, in the searched content for all other users, only content related to the area of interest of the user may be extracted and a content list may be generated and displayed in order of content popularity.

In the present invention, a channel may be changed to a channel of interest of another user linked over the social network or a channel group for content recommended over the social network may be established and a channel may be changed.

If information about the channel group has been changed by ranking change, the user may be informed that information about the channel group has changed in a popup form to enable the user to select whether the channel which is being viewed is maintained or changed.

In addition, real-time content used by other users who log in to the social network service may be collected to determine a popularity order and a real-time order may be measured and re-fed while the users view predetermined broadcasts. Even when another user logs out of the social network service, the user may be informed that the other user logs out of the social network service and the information about the channel group may be changed according to the logout of the predetermined user.

In addition, according to the embodiment, if a broadcast program has ended or the end of a broadcast program is approaching, the broadcast program may be excluded from the content recommendation list.

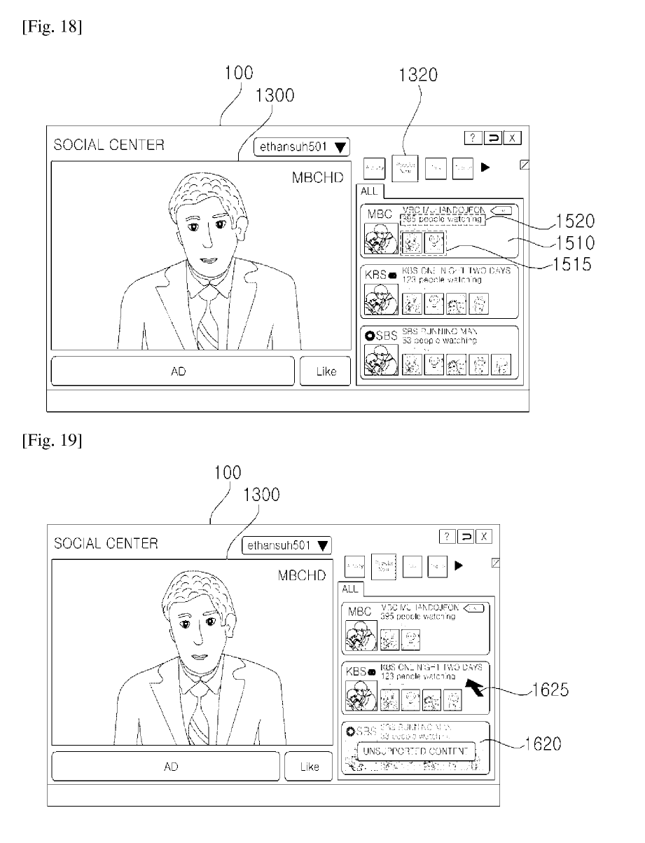

FIGS. 18 to 20 show an example of the case in which the “all” object 1411 is selected. Referring to FIG. 18, the content recommendation list 1510 for all other users linked over the social network may be generated and displayed in order of content popularity.

At this time, the content recommendation list 1510 may include real-time broadcast programs. The content recommendation list 1510 may include broadcast information of a real-time broadcast program, real-time ratings information, and the number 1520 of other users viewing a real-time broadcast program. The broadcast information may include at least one of a channel name, a program name, a program channel number, a name of a broadcaster broadcasting a program, a broadcast start time and a broadcast end time.

In addition, the content recommendation list 1510 may further include a list 1515 of other users who are currently viewing a real-time broadcast program. The list 1515 of the other users may include at least one of the names, SNS accounts and photos of the other users.

Meanwhile, if content included in the content recommendation list 1510 is of a file type which is not supported by the image display apparatus 100, if content is a real-time broadcast program which may not be played back because a region is changed, if content is a broadcast program of an unsupported channel, or if content may not be played back, as shown in FIG. 19, the content may be displayed in an inactive state so as not to be selected. Alternatively, a message 1620 indicating that the content cannot be played back may be displayed or content may be omitted from the content recommendation list 1510.

If input for selecting any one piece of content included in the content recommendation list 1510 displayed on the image display apparatus 100 is received (S1050), the selected content may be played back (1060).

For example, as shown in FIG. 19, if input 1625 for selecting any one of the real-time broadcast programs is received, the controller 170 may extract broadcast information of the selected real-time broadcast program. The extracted broadcast information may include at least one of a channel name, a program name, a program channel number, a broadcast name for broadcasting a program, a broadcast start time and a broadcast end time as described above. The tuner unit 110 may tune to a channel indicated by the extracted broadcast information and receive a real-time broadcast indicated by the broadcast information through the tuned channel.

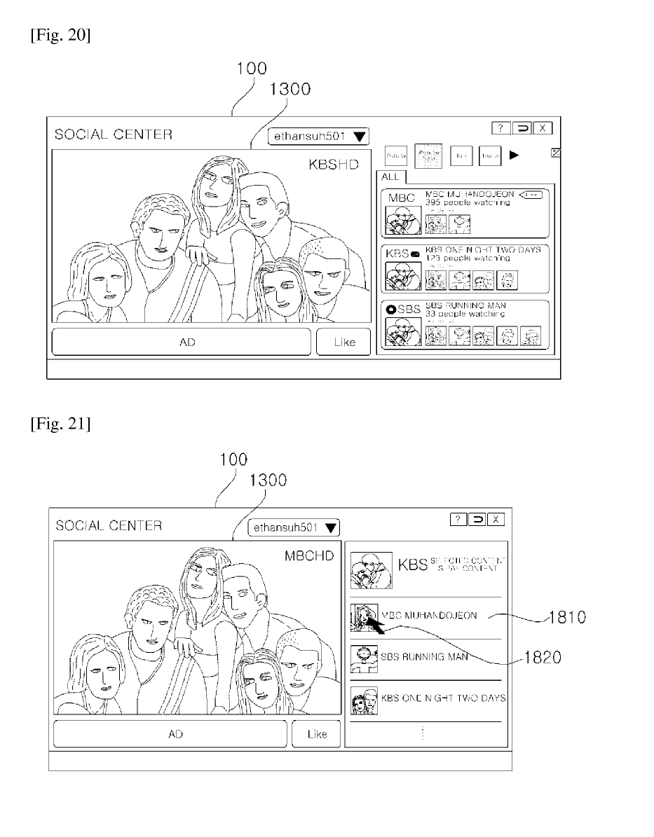

At this time, the display 180 may display the real-time broadcast program in a third area 1300 as shown in FIG. 20.

As shown in FIG. 20, if predetermined content is selected and viewed using the content recommendation list 1510 based on the social network, the image display device 100 may be set to perform another operation in correspondence with command input of the same remote controller 200.

For example, if the user presses a channel down key of the remote controller 200 while viewing a general broadcast program, the image display apparatus changes the broadcast channel to a channel having a channel number less than that of the currently viewed channel.

However, according to one embodiment of the present invention, if the user presses a channel down key of the remote controller 200 while selecting and viewing predetermined content using the content recommendation list 1510, the content may be changed to another item of the content recommendation list.

For example, if the user presses a channel down key of the remote controller 200 while utilizing one piece of content of a content recommendation list, which is a popular broadcast channel list of other users linked over the social network, the channel may be changed to a broadcast channel ranked below the utilized content. A channel up key may change the channel in the direction opposite to that of the channel down key.

Alternatively, if the user presses the channel down key when the content recommendation list 1510 includes a list 1515 of other users who are currently viewing the real-time broadcast program, the selected item may be changed to another item of the list 1515 of the other users.

If the selected content is pay content, as shown in FIG. 21, a popup window 1750 for purchasing the content may be displayed.

If the selected content may not be played back, such as if the selected content is of a file type which is not supported by the image display apparatus 100, if the selected real-time broadcast program is not played back as a region is changed, or if the selected content is a broadcast program of an unsupported channel, a message indicating that the content may not be played back may be displayed.

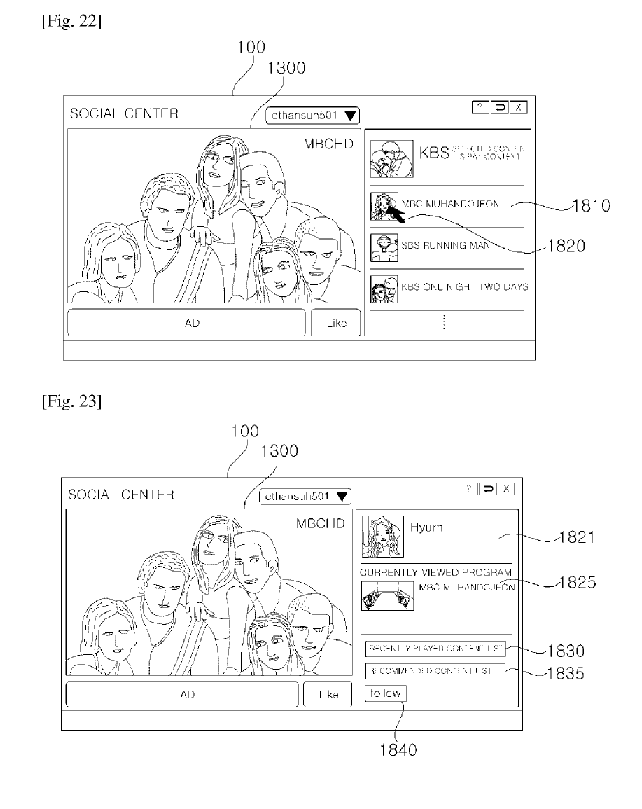

FIGS. 22 to 25 show a method for operating an image display apparatus according to another embodiment of the present invention.

As shown in FIG. 22, a list 1810 indicating other users linked with the user over the social network may be displayed on the display 180.

At this time, the list may include user information of the other users and the user information may include at least one of an SNS account, a name, a photo, an age, an area of interest, a state message and a telephone number.

If input 1820 for selecting any one of the other users included in the list of the other users is received, as shown in FIG. 23, an object 1821 indicating user information of the selected user, an object 1825 indicating information about content which is currently being played back, an object 1830 indicating a list of content which has been played back, an object 1835 indicating a list of content recommended by the other users and an object 1840 indicating a following.

The user information object 1821 may include at least one of an SNS account, a name, a photo, an age, an area of interest, a state message and a telephone number, as described above.

In addition, the object 1825 indicating information about content which is currently being played back may include broadcast information of a real-time broadcast program, real-time ratings information, and the number of users who view the real-time broadcast program among the other users. At this time, the broadcast information may include at least one of a channel name, a program name, a program channel number, a name of a broadcaster broadcasting a program, a broadcast start time and a broadcast end time as described above.

At this time, if the object 1825 indicating information about content which is currently being played back is selected, content associated therewith is played back.

For example, if the currently played content is a real-time broadcast program, the controller 170 may extract broadcast information of the selected real-time broadcast program. The extracted broadcast information may include at least one of a channel name, a program name, a program channel number, a name of a broadcaster broadcasting a program, a broadcast start time and a broadcast end time as described above. The tuner 110 may tune to a channel indicated by the extracted broadcast information and receive a real-time broadcast indicated by the broadcast information through the tuned channel.

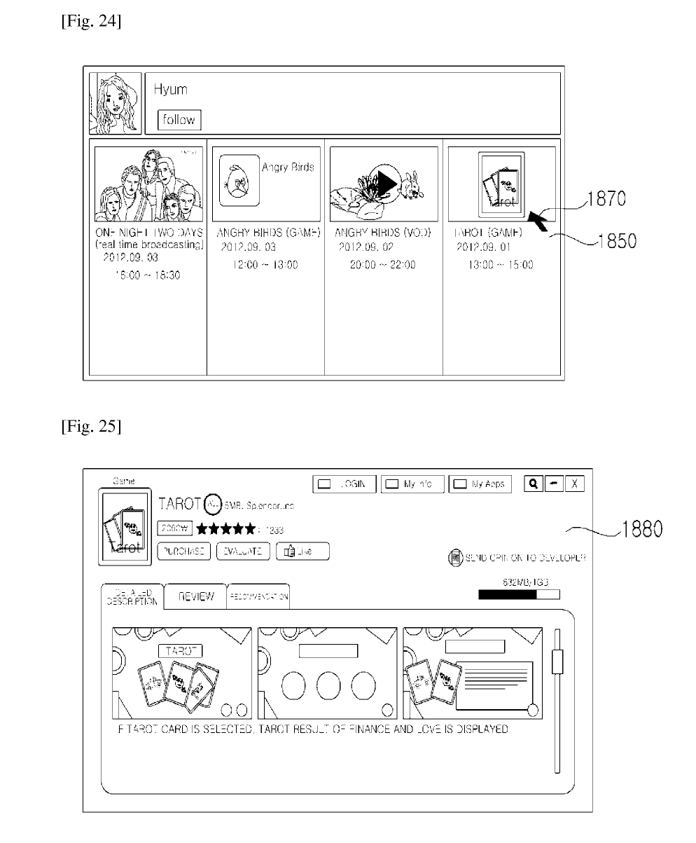

If the object 1830 indicating the list of content which has been played back is selected, as shown in FIG. 24, the list 1850 of content which has been played back by the other users may be displayed and the content list may include content information.

The content information may include at least one of content type information, a content name, a content playback time, a detailed content description, broadcast information (a channel name, a program name, a program channel number, a name of a broadcaster broadcasting a program, a broadcast start time, a broadcast end time, etc.), and a date and time when the user plays the content.

At this time, if any one piece of content included in the content list is selected (1870), the selected content may be played back. For example, as shown in FIG. 25, if game content is selected, a detailed page 1880 including a detailed description of the selected game content is displayed. At this time, the detailed page 1800 may be a web page or a game content playback screen.

If the object 1835 indicating a list of recommended content shown in FIG. 23 is selected, a list of content recommended by the other users may be displayed. If content is selected from the content list, the selected content may be played back.

If the object 1840 indicating the following is selected, the use of the content by the user may be synchronized with the use of the content by another user. If the use of the content is synchronized, whenever the content used by the other user is changed, the content of the user may be changed to be equal to the content of the other user.

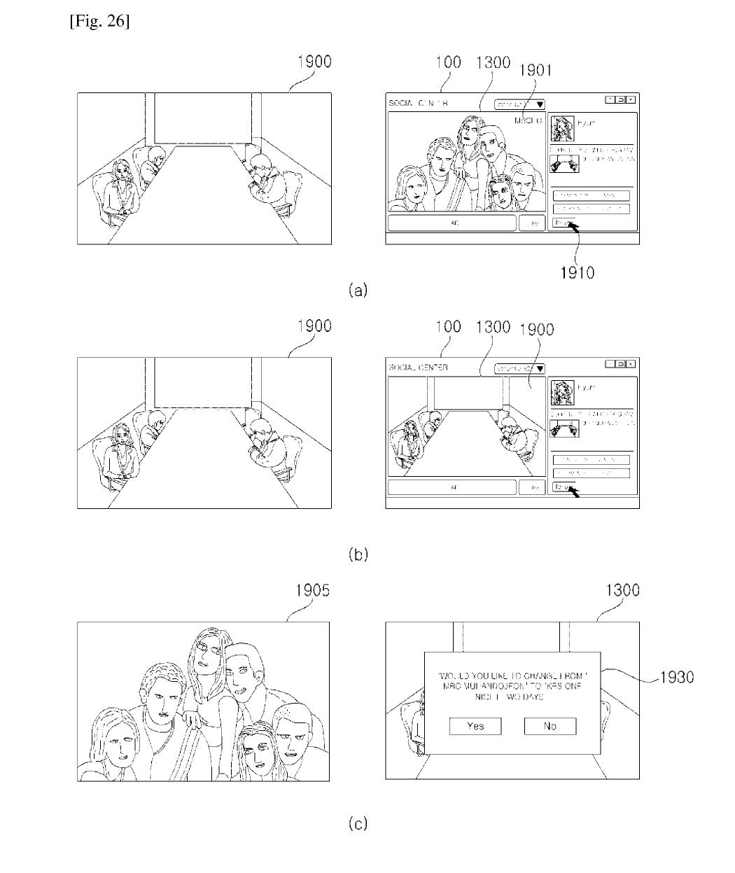

For example, as shown in FIG. 26(a), if a first user views a first channel 1901, a second user views a second channel 1900 and the first user inputs an input signal 1910 for selecting the following object 1840 with respect to the second user, the channel of the first user is synchronized with the channel viewed by the second user and the first channel 1901 of the first user is changed to the second channel 1900 as shown in FIG. 26(b).

At this time, if the second viewer changes the channel to a third channel 1905 while viewing the second channel 1900, as shown in FIG. 26(c), the first user may be informed that the channel viewed by the second user has been changed and a message 1930 asking whether the channel is changed to the channel of the first user may be displayed.

Accordingly, if another user who views real-time broadcast programs in the same order as the user is present, the user follows the other user such that the user may view the same broadcast program as the other user without channel scanning and change. Thus, it is possible to improve user convenience.

In addition, even when the other user who the user follows ends a predetermined broadcast program or logs out, the user may be informed that the other user has ended the predetermined broadcast program or has logged out.

The user may select whether a current service is continuously used, a followee is changed, or the type of a content recommendation list is changed, according to preference.

The image display apparatus, the server and the method for operating the same according to the present invention are not restricted to the embodiments set forth herein. Therefore, variations and combinations of the exemplary embodiments set forth herein may fall within the scope of the present invention.

The method for operating an image display apparatus according to the foregoing embodiments may be implemented as code that can be written to a computer-readable recording medium and can thus be read by a processor. The computer-readable recording medium may be any type of recording device in which data can be stored in a computer-readable manner. Examples of the computer-readable recording medium include a ROM, a RAM, a CD-ROM, a magnetic tape, a floppy disk, optical data storage, and a carrier wave (e.g., data transmission over the Internet). The computer-readable recording medium may be distributed over a plurality of computer systems connected to a network so that computer-readable code is written thereto and executed therefrom in a decentralized manner. Functional programs, code, and code segments to realize the embodiments herein can be construed by one of ordinary skill in the art.

### Mode for the Invention

Various embodiments have been described in the best mode for carrying out the invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for operating an image display apparatus, the method comprising:
receiving user input for requesting content recommendation;
transmitting a message requesting information about a user and a content recommendation list to a server;
receiving, from the server, the content recommendation list based on content viewing information of other users linked with the user over a social network;
displaying the received content recommendation list;
receiving input for selecting at least one piece of content from the content recommendation list; and
playing back the selected content.

2. The method according to claim 1, wherein the content recommendation list is based on at least one of an age, gender, activity index and area of interest of the user.

3. The method according to claim 1, wherein the content includes at least one of a real-time broadcast program, a game, a moving image, audio, text and an application.

4. The method according to claim 1, further comprising logging in to a server providing a social network service.

5. The method according to claim 1, wherein, if the content recommendation list includes real-time broadcast programs, the content recommendation list includes real-time viewing information of the real-time broadcast programs.

6. The method according to claim 5, wherein the real-time viewing information includes information about other users who view the real-time broadcast programs.

7. The method according to claim 1, wherein the content recommendation list includes information indicating whether the content included in the list is able to be played back on the image display apparatus.

8. The method according to claim 1, wherein, if real-time broadcast content is selected from the content included in the content recommendation list, a channel is changed to the selected real-time broadcast.

9. The method according to claim 1, wherein, if pay content is selected from content included in the content recommendation list, a message asking whether to purchase the pay content is displayed.

10. The method according to claim 1, wherein:
the content recommendation list includes a content synchronization object indicating content synchronization with another user, and if the content synchronization object is selected, the content is changed to be equal to the content used by the other user whenever content played back by the other user is changed.

11. A method for operating a server, the method comprising:
receiving a content recommendation list request message from an image display apparatus;
requesting information about other users linked with a user of the image display apparatus over a social network from a server providing a social network service;
generating a content recommendation list based on the information about the other users and content use information of the other users; and
transmitting the content recommendation list to the image display apparatus.

12. The method according to claim 11, further comprising receiving the content use information of the other users.

13. The method according to claim 12, further comprising storing the content use information of the other users in association with the information about the other users.

14. An image display apparatus comprising:
a network interface configured to receive, from a server, a content recommendation list based on content viewing information of other users linked with a user of the image display apparatus over a social network;
a display configured to display the received content recommendation list; and
a controller configured to receive input for selecting at least one piece of content from the content recommendation list and to play back the selected content.

15. The image display apparatus according to claim 14, wherein the content recommendation list is based on at least one of an age, gender, activity index and area of interest of the user.

16. The image display apparatus according to claim 14, wherein the content includes at least one of a real-time broadcast program, a game, a moving image, audio, text and an application.

17. The image display apparatus according to claim 14, wherein, if the content recommendation list includes real-time broadcast programs, the display displays real-time viewing information of the real-time broadcast programs.

18. The image display apparatus according to claim 14, wherein the display displays information indicating whether content included in the list is able to be played back on the image display apparatus.

19. The image display apparatus according to claim 14, wherein, if pay content is selected from content included in the content recommendation list, the controller controls display of a message asking whether to purchase the pay content.

20. The image display apparatus according to claim 14, wherein:
the content recommendation list includes a content synchronization object indicating content synchronization with another user, and
if the content synchronization object is selected, the controller controls the content to be changed to be equal to the content used by the other user, whenever content played back by the other user is changed.
